(19) United States
(12) Patent Application Publication
(10) Pub. No.: US 2023/0380498 A1
(43) Pub. Date: Nov. 30, 2023

(54) AEROSOL GENERATION DEVICE AND INFRARED HEATER

(71) Applicant: SHENZHEN FIRST UNION TECHNOLOGY CO., LTD., Shenzhen City, Guangdong Province (CN)

(72) Inventors: ZUQIANG QI, Shenzhen City, Guangdong Province (CN); SHEN QI, Shenzhen City, Guangdong Province (CN); JIAMAO LUO, Shenzhen City, Guangdong Province (CN); BAOLING LEI, Shenzhen City, Guangdong Province (CN); ZHONGLI XU, Shenzhen City, Guangdong Province (CN); YONGHAI LI, Shenzhen City, Guangdong Province (CN)

(21) Appl. No.: 18/027,626

(22) PCT Filed: Sep. 22, 2021
(86) PCT No.: PCT/CN2021/119650

§ 371 Date: Mar. 22, 2023

(30) Foreign Application Priority Data
Sep. 22, 2020 (CN) 202022087961.4

(51) Int. Cl. A24F 40/46; A24F 40/51

(52) U.S. Cl. CPC A24F 40/46; A24F 40/51; A24F 40/57

(57) ABSTRACT

This application relates to cigarette devices, and provides an aerosol generation device and an infrared heater. The aerosol generation device includes a chamber configured to receive an aerosol forming substrate, at least one infrared heater, and a battery cell providing power to the infrared heater, where the infrared heater includes: a carbon material heating film, having a first surface and a second surface opposite to each other; and the first surface faces the chamber; and the carbon material heating film is configured to radiate infrared to the chamber, to heat the aerosol forming substrate received in the chamber; a flexible substrate, bound onto the second surface; and a conductive element, configured to provide the power to the carbon material heating film. A carbon material heating film radiates infrared to heat an aerosol forming substrate received in a chamber, and the infrared does not need to penetrate a quartz tube.

### CROSS-REFERENCE TO RELATED APPLICATIONS

This application claims priority to Chinese Patent Application No. 202022087961.4, filed with the China National Intellectual Property Administration on Sep. 22, 2020 and entitled “AEROSOL GENERATION DEVICE AND INFRARED HEATER”, which is incorporated herein by reference in its entirety.

### TECHNICAL FIELD

Embodiments of this application relate to the field of cigarette device technologies, and in particular, to an aerosol generation device and an infrared heater.

### BACKGROUND

During use of smoking objects such as a cigarette or cigar, tobaccos are burnt to generate vapor. A product that releases compounds without burning has been tried to provide an alternative for the objects that burn tobaccos. An example of the products is a heat-not-burn product, which releases compounds by heating tobaccos rather than burning tobaccos.

In an existing low-temperature heat-not-burn cigarette device, an outer surface of a quartz tube is mainly coated with a far-infrared coating and a conductive coating, and the electrified far-infrared coating emits far-infrared to penetrate the quartz tube and heat a cigarette in the quartz tube. Because the far-infrared has relatively strong penetrability, and may penetrate the periphery of the cigarette to enter the cigarette, an aerosol forming substrate in the cigarette is heated relatively evenly.

A problem existing in the cigarette device is that, the quartz tube affects a transmission band of the far-infrared, and then affects infrared heating efficiency.

### SUMMARY

This application provides an aerosol generation device and an infrared heater, aiming to resolve the problem that a quartz tube affects a transmission band of far-infrared in an existing cigarette device.

An aspect of this application provides an aerosol generation device, including a chamber configured to receive an aerosol forming substrate, at least one infrared heater, and a battery cell providing power to the infrared heater, where
the infrared heater includes:
a carbon material heating film, having a first surface and a second surface opposite to each other; and the first surface faces the chamber; and the carbon material heating film is configured to radiate infrared to the chamber, to heat the aerosol forming substrate received in the chamber;
a flexible substrate, bound onto the second surface; and
a conductive element, configured to provide the power to the carbon material heating film.

Another aspect of this application provides an infrared heater for an aerosol generation device, the aerosol generation device including a chamber configured to receive an aerosol forming substrate and a battery cell providing power to the infrared heater, where the infrared heater includes:
a carbon material heating film, having a first surface and a second surface opposite to each other; and the first surface faces the chamber; and the carbon material heating film is configured to radiate infrared to the chamber, to heat the aerosol forming substrate received in the chamber;
a flexible substrate, bound onto the second surface; and
a conductive element, configured to provide the power to the carbon material heating film.

In the aerosol generation device and the infrared heater provided in this application, a carbon material heating film radiates infrared to heat an aerosol forming substrate received in a chamber, and the infrared does not need to penetrate a quartz tube, to prevent the quartz tube from affecting a transmission band of far-infrared and improve infrared heating efficiency.

### BRIEF DESCRIPTION OF THE DRAWINGS

One or more embodiments are described by way of example with reference to the corresponding figures in the accompanying drawings, and the exemplary descriptions are not to be construed as limiting the embodiments. Elements/modules and steps in the accompanying drawings that have same reference numerals are represented as similar elements/modules and steps, and unless otherwise particularly stated, the figures in the accompanying drawings are not drawn to scale.

FIG. 1 is a schematic diagram of an aerosol generation device according to an implementation of this application;

FIG. 2 is a schematic diagram of an aerosol generation device with a cigarette inserted according to an implementation of this application;

FIG. 3 is a schematic diagram of an infrared heater according to an implementation of this application;

FIG. 4 is a schematic diagram of an infrared heater unfolded according to an implementation of this application; and

FIG. 5 is a schematic diagram of another infrared heater according to an implementation of this application.

### DETAILED DESCRIPTION

For ease of understanding of this application, this application is described below in more detail with reference to accompanying drawings and specific implementations. It should be noted that, when an element is expressed as “being fixed to” another element, the element may be directly on the another element, or one or more intermediate elements may exist between the element and the another element. When an element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as those usually understood by a person skilled in art of this application. Terms used in this specification of this application are merely intended to describe objectives of the specific implementations, and are not intended to limit this application. The term “and/or” used in this specification includes any or all combinations of one or more related listed items.

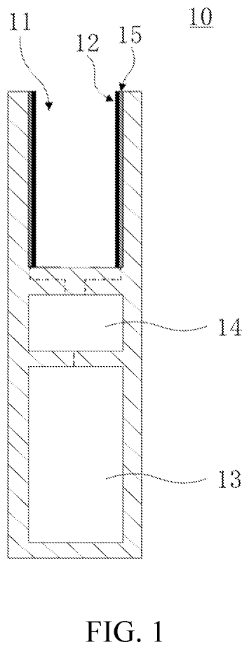

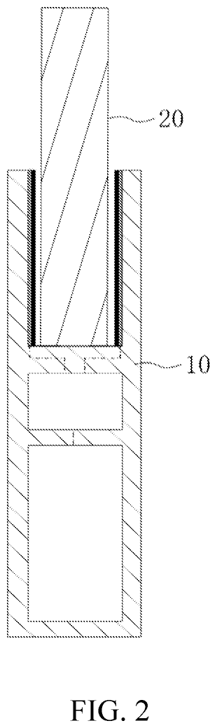

FIG. 1 and FIG. 2 show an aerosol generation device 10 provided in an implementation of this application and including the following:

A chamber 11 is configured to receive an aerosol forming substrate 20, for example, a cigarette.

The aerosol-forming substrate is a substrate that can release a volatile compound that can form an aerosol. The volatile compound can be released by heating the aerosol-forming substrate. The aerosol-forming substrate may be solid, or liquid, or components including solid and liquid. The aerosol-forming substrate may be loaded onto a carrier or support through adsorbing, coating, impregnating, or in other manners. The aerosol-forming substrate may conveniently be a part of the aerosol-forming article.

The aerosol-forming substrate may include nicotine. The aerosol-forming substrate may include tobacco, for example, a tobacco-containing material including a volatile tobacco aroma compound. The volatile tobacco aroma compound is released from the aerosol-forming substrate when heated. Preferably, the aerosol-forming substrate may include a homogeneous tobacco material. The aerosol-forming substrate may include at least one aerosol-forming agent, and the aerosol-forming agent may be any suitable known compound or a mixture of compounds. During use, the compound or the mixture of compounds facilitates condensing and stabilizing formation of the aerosol and is substantially resistant to thermal degradation at an operating temperature of an aerosol-forming system. Suitable aerosol-forming agents are well known in the related art and include, but are not limited to: polyol, such as triethylene glycol, 1,3-butanediol, and glycerol; ester of polyol, such as glycerol mono-, di- or triacetate; and fatty acid ester of mono-, di- or polycarboxylic acid, such as dimethyl dodecanedioate and dimethyl tetradecanedioate. Preferably, the aerosol forming agent is polyhydric ester or a mixture thereof, such as triethylene glycol, 1,3-butanediol, or most preferably, glycerol.

The infrared heater 12 includes a plurality of carbon material heating tubes; and the plurality of carbon material heating tubes are constructed to heat the aerosol forming substrate received in the chamber 11 at least in an infrared radiation manner.

A battery cell 13 provides power used for operating the aerosol generation device 10. For example, the battery cell 13 may provide power to heat the infrared heater 12. Moreover, the battery cell 13 may provide power required for operating other elements provided in the aerosol generation device 10.

The battery cell 13 may be a rechargeable battery or a disposable battery. The battery cell 13 may be, but is not limited to, a lithium iron phosphate (LiFePO4) battery. For example, the battery cell 13 may be a lithium cobaltate (LiCoO2) battery or a lithium titanate battery.

A circuit 14 may control an overall operation of the aerosol generation device 10. The circuit 14 not only controls operations of the battery cell 13 and the infrared heater 12, but also controls operations of other elements in the aerosol generation device 10. For example, the circuit 14 obtains information about a temperature of the infrared heater 12 sensed by a temperature sensor 125, and controls, according to the information, power provided by the battery cell 13 to the infrared heater 12.

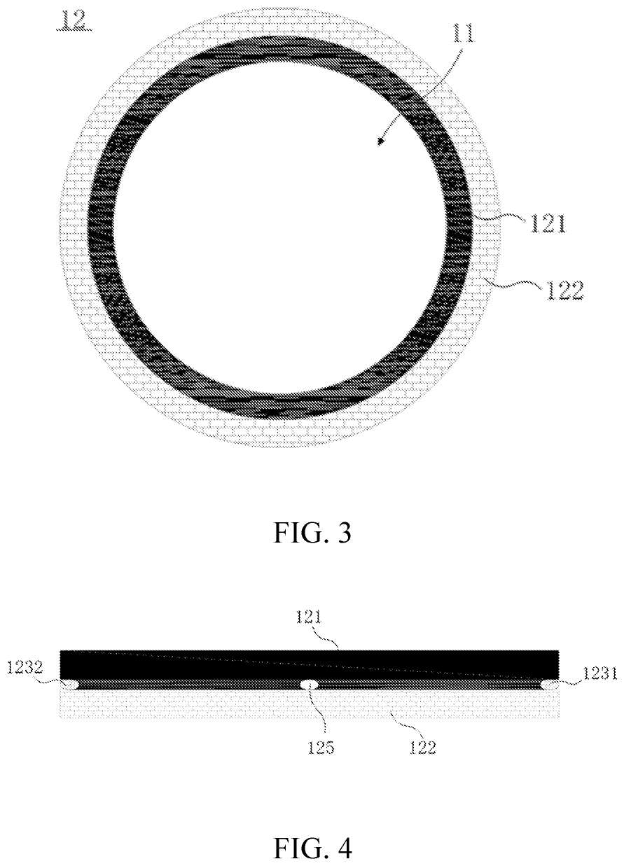

FIG. 3 to FIG. 5 show an infrared heater 12 according to an implementation of this application. The infrared heater 12 includes a carbon material heating film 121 and a flexible substrate 122.

As shown in FIG. 3, In this example, each of the carbon material heating film 121 and the flexible substrate 122 is windable to form a tube shape extending in an axial direction of the chamber 11 and surrounding the chamber 11.

Specifically, an inner surface (or a first surface) of the carbon material heating film 121 faces the chamber 11, and an outer surface (or a second surface) of the carbon material heating film 121 is bound onto an inner surface of the flexible substrate 122. The carbon material may be selected from a derivative and a compound having carbon as some or all component elements and including, but not limited to, one or more a carbon nanotube film, a graphene film, a carbon fiber film, a carbon film, and a carbon fiber cloth. The formed carbon material heating film 121 has a specific rigidity, and may be wound together with the flexible substrate 122 to form a tube shape. The flexible substrate 122 may be made of a material such as flexible glass, PI (polyimide) film, or flexible ceramic paper, preferably PI film.

It should be noted that, in another example, it is also possible that the carbon material heating film 121 and the flexible substrate 122 are wound into a non-tube shape, for example, a sheet shape or an ellipse shape.

In this example, an inner diameter of the tubular structure formed by winding the carbon material heating film 121 is slightly greater than an outer diameter of an aerosol generation product (for example, a cigarette), so that the inner surface of the carbon material heating film 121 and the aerosol forming substrate received in the chamber 11 are spaced apart. In this way, in an aspect, it is convenient to insert the aerosol generation product into the chamber 11, and in another aspect, it is convenient for the carbon material heating film 121 to radiate infrared to perform heating.

Further, the inner surface of the carbon material heating film 121 may be bound onto another flexible substrate. In this way, in an aspect, a problem of oxidization of the carbon material caused due to long-time use may be avoided, and in another aspect, wear of the carbon material heating film 121 caused when the aerosol generation product is inserted may be avoided.

As shown in FIG. 4, the infrared heater 12 further includes a conductive element, and the conductive element is configured to provide power of the battery cell 13 to the carbon material heating film 121.

In this example, the conductive element includes a first electrode 1231 and a second electrode 1232 spaced apart between the outer surface of the carbon material heating film 121 and the flexible substrate 122.

The first electrode 1231 and the second electrode 1232 may be made of materials of metal or alloy with a low resistivity, such as silver, gold, palladium, platinum, copper, nickel, molybdenum, tungsten, niobium, or an alloy material of the foregoing metals. In an example, the first electrode 1231 and the second electrode 1232 may be metal sheets spaced apart between the outer surface of the carbon material heating film 121 and the flexible substrate 122; the first electrode 1231 and the second electrode 1232 may alternatively be conductive coatings formed on the outer surface of the carbon material heating film 121, for example, printed on the outer surface of the carbon material heating film 121 in a silk-screen printing manner; and the first electrode 1231 and the second electrode 1232 may alternatively be electrodes formed on the flexible substrate 122.

In another example, if the inner surface of the carbon material heating film 121 is bound onto another flexible substrate, a conductive element may alternatively be arranged between the inner surface of the carbon material heating film 121 and another flexible substrate.

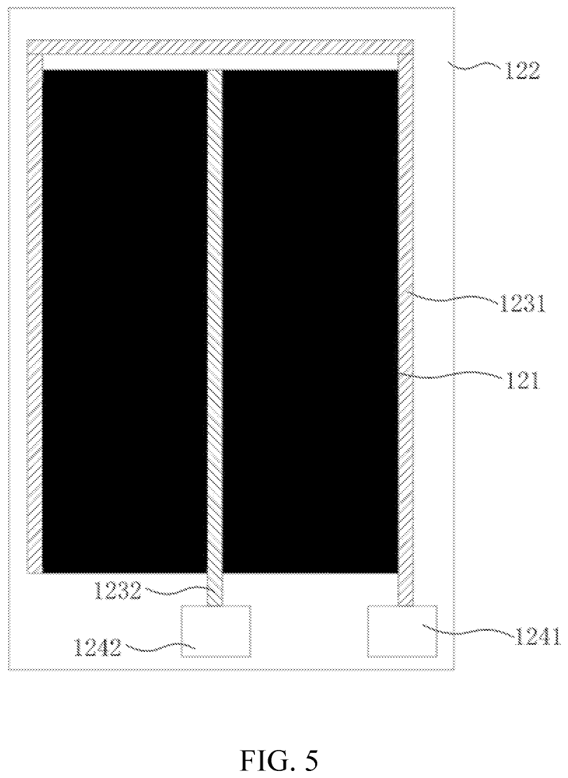

Further, referring to FIG. 5, the area of the inner surface of the flexible substrate 122 is greater than the area of the outer surface of the carbon material heating film 121, and a part of the flexible substrate 122 not overlapping the carbon material heating film 121 has a first coupling portion 1241 electrically connected to the first electrode 1231 and a second coupling portion 1242 electrically connected to the second electrode 1232; and the first coupling portion 1241 and the second coupling portion 1242 are configured to be coupled to an anode and a cathode of the battery cell 13. In the example, the first electrode 1231 and the second electrode 1232 are in a comb shape, and the resistance of the carbon material heating film 121 may be adjusted through the arrangement in the comb shape.

Referring to FIG. 4 again, the infrared heater 12 further includes a temperature sensor 125 arranged between the outer surface of the carbon material heating film 121 and the flexible substrate 122, and the temperature sensor 125 is configured to sense a temperature of the infrared heater 12.

The temperature sensor 125 may be a thermocouple temperature sensor that calculates the temperature by calculating thermoelectromotive forces at two ends; and the temperature sensor 125 may alternatively be a conductive trajectory formed on the flexible substrate 122 and characterized by a resistance temperature coefficient.

Referring to FIG. 1 again, the infrared heater 12 further includes a holding member 15, the holding member 15 may be but is not limited to a hollow tubular structure member, and the hollow tubular structure member is arranged on a periphery of the infrared heater 12. The holding member 15 is configured to hold the infrared heater 12. Specifically, the flexible substrate 122 may be stuck onto the inner surface of the holding member 15 through a high-temperature resistant inorganic adhesive. Further, an infrared reflection layer may be further formed on an inner surface of the hollow tubular structure member, and the infrared reflection layer may reflect the infrared radiated by the infrared heater 12 to the chamber 11, to improve infrared heating efficiency. The infrared emitting layer may be made of one or more of gold, silver, nickel, aluminum, gold alloy, silver alloy, nickel alloy, aluminum alloy, gold oxide, silver oxide, nickel oxide, aluminum oxide, titanium oxide, zinc oxide, and cerium dioxide.

It should be noted that, the foregoing embodiment is described with only one infrared heater 12 as an example. In another example, the aerosol generation device 10 may include a first infrared heater and a second infrared heater, and the first infrared heater and the second infrared heater are constructed to independently start to implement segmented heating.

For structures of the first infrared heater and the second infrared heater, reference may be made to the foregoing content. Details are not described herein. The first infrared heater and the second infrared heater may be arranged in an axial direction of a chamber 11, to heat different parts in an axial direction of an aerosol forming substrate, and then implement segmented heating; and may alternatively be arranged in a circumferential direction of the chamber 11, to heat different parts in the circumferential direction of the aerosol forming substrate, and then implement segmented heating.

It should be noted that, this specification of this application and the accompanying drawings thereof illustrate preferred embodiments of this application. However, this application can be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the foregoing technical features are further combined to form various embodiments not listed above, and all such embodiments shall be construed as falling within the scope of this application. Further, a person of ordinary skill in the art may make improvements or variations according to the above descriptions, and such improvements and variations shall all fall within the protection scope of the appended claims of this application.

1. An aerosol generation device, comprising a chamber configured to receive an aerosol forming substrate, at least one infrared heater, and a battery cell providing power to the infrared heater, wherein:
the infrared heater comprises:
a carbon material heating film, having a first surface and a second surface opposite to each other; and the first surface faces the chamber; and the carbon material heating film is configured to radiate infrared to the chamber, to heat the aerosol forming substrate received in the chamber;
a flexible substrate, bound onto the second surface; and
a conductive element, configured to provide the power to the carbon material heating film.

2. The aerosol generation device according to claim 1, wherein each of the carbon material heating film and the flexible substrate is windable to form a tube shape extending in an axial direction of the chamber and surrounding the chamber.

3. The aerosol generation device according to claim 1, wherein the first surface and the aerosol forming substrate received in the chamber are spaced apart.

4. The aerosol generation device according to claim 1, wherein the infrared heater further comprises another flexible substrate bound onto the first surface.

5. The aerosol generation device according to claim 1, wherein the conductive element comprises a first electrode and a second electrode spaced apart between the second surface and the flexible substrate.

6. The aerosol generation device according to claim 5, wherein the first electrode and the second electrode are conductive coatings formed on the second surface; or
the first electrode and the second electrode are electrodes formed on the flexible substrate.

7. The aerosol generation device according to claim 6, wherein the flexible substrate has a part not overlapping the carbon material heating film, and the part has a first coupling portion electrically connected to the first electrode and a second coupling portion electrically connected to the second electrode; and
the first coupling portion and the second coupling portion are coupled to an anode and a cathode of the battery cell respectively.

8. The aerosol generation device according to claim 1, wherein the infrared heater further comprises a temperature sensor arranged between the second surface and the flexible substrate, and the temperature sensor is configured to sense a temperature of the infrared heater.

9. The aerosol generation device according to claim 8, wherein the temperature sensor is a conductive trajectory formed on the flexible substrate and characterized by a resistance temperature coefficient.

10. The aerosol generation device according to claim 1, wherein the infrared heater further comprises a holding member, and the flexible substrate is held on the holding member.

11. An infrared heater for an aerosol generation device, the aerosol generation device comprising a chamber configured to receive an aerosol forming substrate and a battery cell providing power to the infrared heater, wherein the infrared heater comprises:
a carbon material heating film, having a first surface and a second surface opposite to each other; and the first surface faces the chamber; and the carbon material heating film is configured to radiate infrared to the chamber, to heat the aerosol forming substrate received in the chamber;
a flexible substrate, bound onto the second surface; and
a conductive element, configured to provide the power to the carbon material heating film.

12. The aerosol generation device according to claim 2, wherein the conductive element comprises a first electrode and a second electrode spaced apart between the second surface and the flexible substrate.

13. The aerosol generation device according to claim 12, wherein the first electrode and the second electrode are conductive coatings formed on the second surface; or
the first electrode and the second electrode are electrodes formed on the flexible substrate.

14. The aerosol generation device according to claim 13, wherein the flexible substrate has a part not overlapping the carbon material heating film, and the part has a first coupling portion electrically connected to the first electrode and a second coupling portion electrically connected to the second electrode; and
the first coupling portion and the second coupling portion are coupled to an anode and a cathode of the battery cell respectively.

15. The aerosol generation device according to claim 3, wherein the conductive element comprises a first electrode and a second electrode spaced apart between the second surface and the flexible substrate.

16. The aerosol generation device according to claim 15, wherein the first electrode and the second electrode are conductive coatings formed on the second surface; or
the first electrode and the second electrode are electrodes formed on the flexible substrate.

17. The aerosol generation device according to claim 16, wherein the flexible substrate has a part not overlapping the carbon material heating film, and the part has a first coupling portion electrically connected to the first electrode and a second coupling portion electrically connected to the second electrode; and
the first coupling portion and the second coupling portion are coupled to an anode and a cathode of the battery cell respectively.

18. The aerosol generation device according to claim 4, wherein the conductive element comprises a first electrode and a second electrode spaced apart between the second surface and the flexible substrate.

19. The aerosol generation device according to claim 18, wherein the first electrode and the second electrode are conductive coatings formed on the second surface; or
the first electrode and the second electrode are electrodes formed on the flexible substrate.

20. The aerosol generation device according to claim 19, wherein the flexible substrate has a part not overlapping the carbon material heating film, and the part has a first coupling portion electrically connected to the first electrode and a second coupling portion electrically connected to the second electrode; and
the first coupling portion and the second coupling portion are coupled to an anode and a cathode of the battery cell respectively.
